(19) United States
(12) Patent Application Publication
(10) Pub. No.: US 2011/0239521 A1
(43) Pub. Date: Oct. 6, 2011

(54) Compact Fake Bait Structure

(76) Inventor: Tsung-Hsi Tsai, Changhua City (TW)

(21) Appl. No.: 12/750,045

(22) Filed: Mar. 30, 2010

(51) Int. Cl. A01K 85/00

(52) U.S. Cl. 43/42.15; 43/42.47

(57) ABSTRACT

A compact fake bait structure includes a transparent counterweight fake bait, at least one dual-ring member and a colored fake bait. The transparent counterweight fake bait has an opening at a rear end thereof for connecting with one end of the dual-ring member. Another end of the dual-ring member is pivotally connected with a front end of the colored fake bait. When the user tosses a fishing line, the fishing line can be tossed farther through the gravitational acceleration of the transparent counterweight fake bait. The colored fake bait colored with pattern and connected with the dual-ring ring swings at the rear end of the transparent counterweight fake bait like a real fish so as to attract a real fish to be hooked easily. Besides, the transparent counterweight fake bait is not easily to be seen, preventing the real fish from being frightened away.

### BACKGROUND OF THE INVENTION

1. Field of the Invention

The present invention relates to a compact fake bait structure, and more particularly to one having a transparent counterweight fake bait, at least one dual-ring member and a colored fake bait. The transparent counterweight fake bait has an opening at a rear end thereof for connecting with one end of the dual-ring member. Another end of the dual-ring member is pivotally connected with a front end of the colored fake bait. The counterweight fake bait is not easily to be seen and facilitates a fishing line to be tossed farther when flinging a fishing rod. The colored fake bait colored with pattern can attract a small real fish to be hooked easily.

2. Description of the Prior Art

A fake fish is used as an auxiliary tool for fishing. The fake fish is provided with a plurality of fishhooks. The fake fish is brightly colored like a rear fish for attracting fish to approach the baits on the fishhooks so as to hook fish. However, the size of the fake bait is not uniform. If the fake bait is too big, the real fish won't dare to approach the fake bait. If the fake bait is too small, the fake bait will be very light, so that the fishing line can't be tossed far.

### SUMMARY OF THE INVENTION

The primary object of the present invention is to provide a compact fake bait structure which comprises a transparent counterweight fake bait, at least one dual-ring member and a colored fake bait. The transparent counterweight fake bait has an opening at a rear end thereof for connecting with one end of the dual-ring member. Another end of the dual-ring member is pivotally connected with a front end of the colored fake bait. When the user tosses a fishing line, the fishing line can be tossed farther through the gravitational acceleration of the transparent counterweight fake bait. The colored fake bait colored with pattern and connected with the dual-ring ring swings at the rear end of the transparent counterweight fake bait like a real fish so as to attract a real fish to be hooked easily. Besides, the transparent counterweight fake bait is not easily to be seen, preventing the real fish from being frightened away.

Preferably, the transparent counterweight fake bait is in the form of a plurality of transparent counterweight fake baits which are connected one by one to add its weight and the last one is connected with the colored fake bait, which can facilitate the fishing line to be tossed farther when flinging a fishing rod.

### BRIEF DESCRIPTION OF THE DRAWINGS

FIG. 1 is an exploded view of the present invention;

FIG. 2 is a perspective view of the present invention;

FIG. 3 is a cross-sectional view of the present invention;

FIG. 4 is a schematic view showing the swing of the colored fake bait of the present invention; and

FIGS. 5-A and 5-B are schematic views showing the operation of the present invention.

### DETAILED DESCRIPTION OF THE PREFERRED EMBODIMENT

Embodiments of the present invention will now be described, by way of example only, with reference to the accompanying drawings.

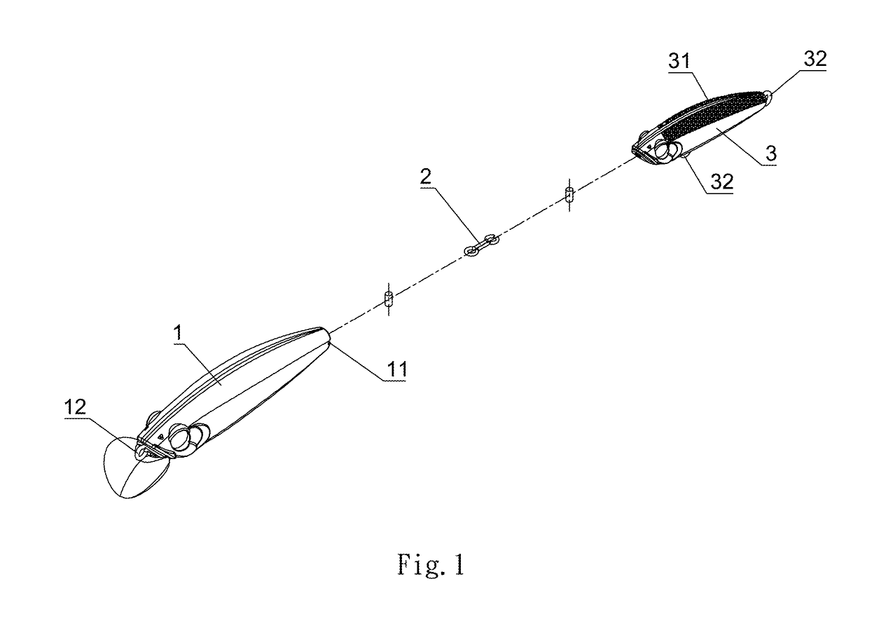

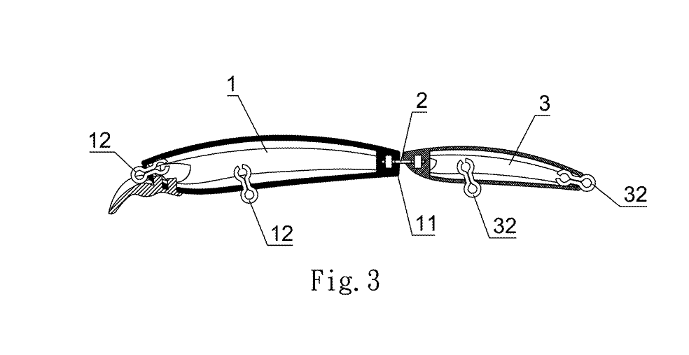

Referring to FIGS. 1 to 3, a compact fake bait structure according to a preferred embodiment of the present invention comprises a transparent counterweight fake bait 1, at least one dual-ring member 2, and a colored fake bait 3. The transparent counterweight fake bait 1 has an opening 11 at a rear end thereof for connecting with one end of the dual-ring member 2. Another end of the dual-ring member 2 is pivotally connected with a front end of the colored fake bait 3. The transparent counterweight fake bait 1 has appropriate weight for the weight of a toss and connection rings 12 to connect with a fishing line 4 and a fishhook 5. The colored fake bait 3 is colored with pattern 31 for attracting a real fish to be hooked easily and provided with connection rings 32 to connect with the fishhook 5.

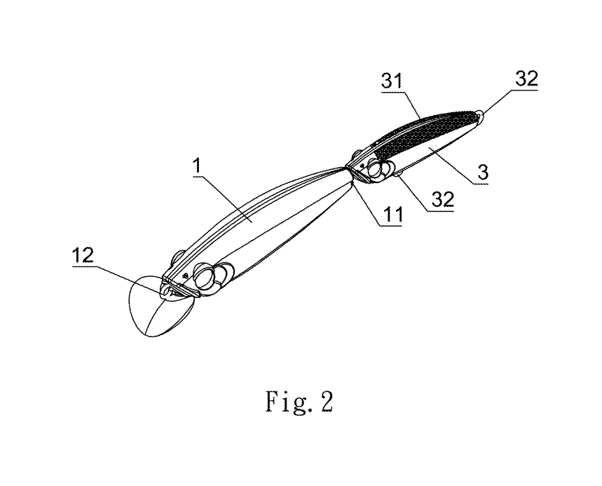

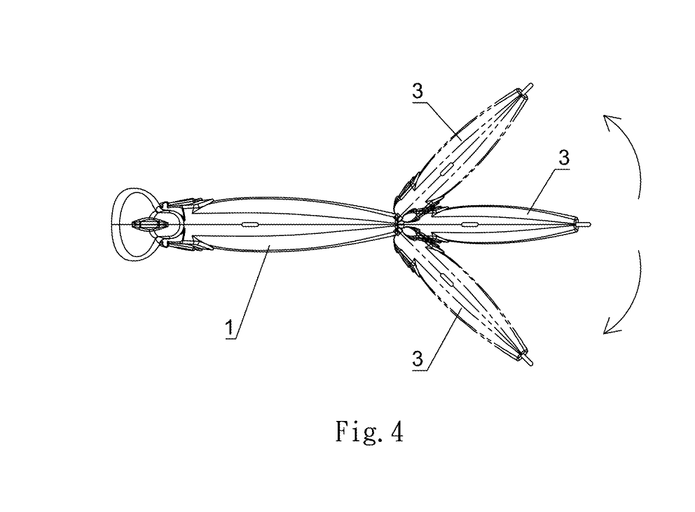

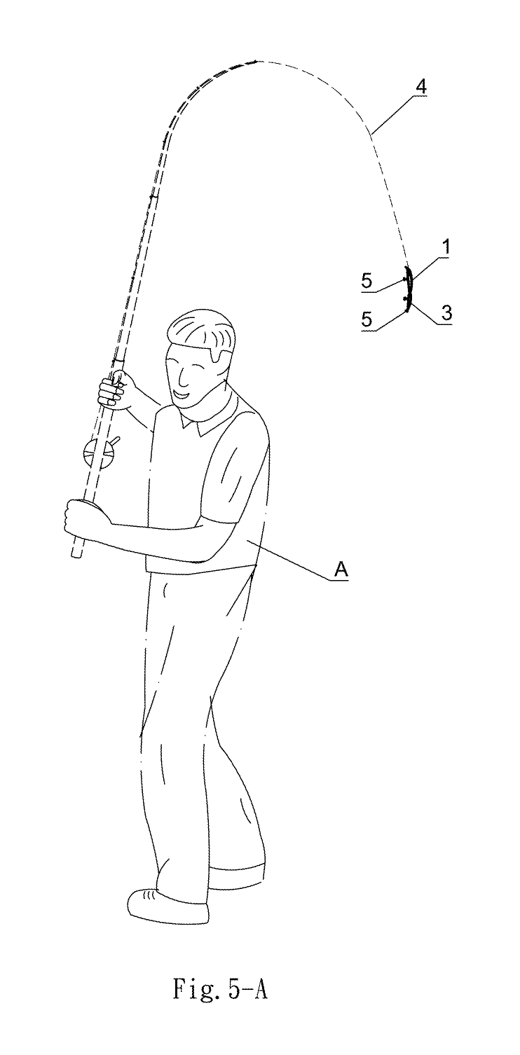

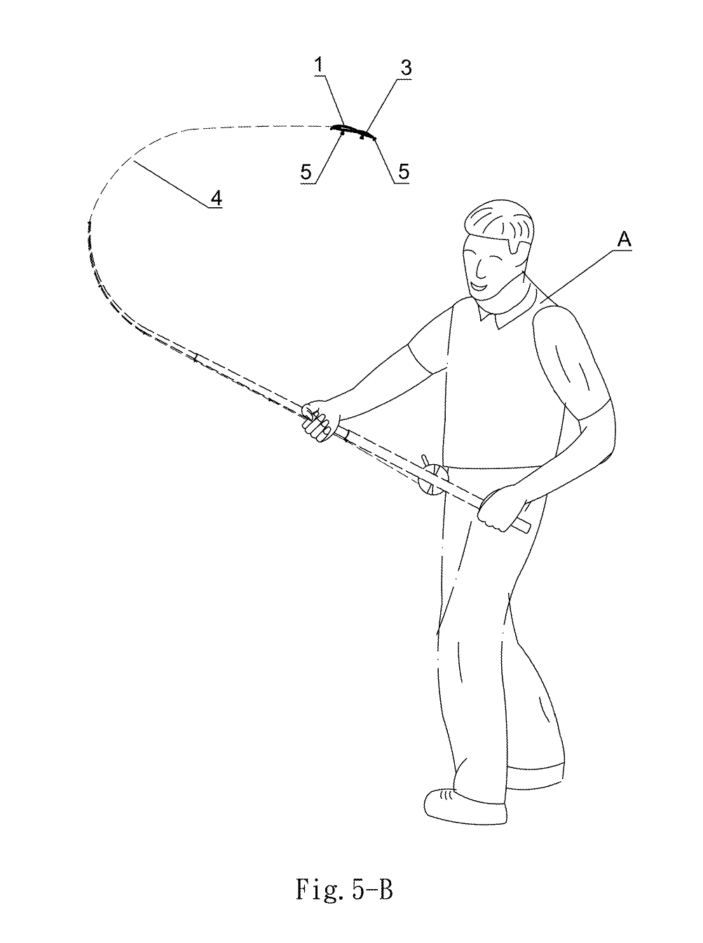

As shown in FIG. 2, FIG. 4, FIG. 5-A and FIG. 5-B, when the user A tosses the fishing line 4, the fishing line 4 will be tossed farther due to the gravitational acceleration of the transparent counterweight fake bait 1. The size of the colored fake bait 3 is smaller than that of the transparent counterweight fake bait 1. The colored fake bait 3 colored with the pattern 31 and connected with the dual-ring ring 2 swings at the rear end of the transparent counterweight fake bait 1 like a real fish so as to attract a real fish to be hooked easily. Besides, the transparent counterweight fake bait 1 is not easily to be seen, preventing the real fish from being frightened away.

Referring to FIG. 1, the transparent counterweight fake bait 1 can be in the form of a plurality of transparent counterweight fake baits which are connected one by one to add its weight and the last one is connected with the colored fake bait 3, which can facilitate the fishing line 4 to be tossed farther when flinging a fishing rod.

The size of the colored fake bait 3 can be varied corresponding in size to the fish in sea water, lake water or river for attracting fish in different sizes to be hooked by the fishhook 5 easily.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A compact fake bait structure, comprising a transparent counterweight fake bait, at least one dual-ring member and a colored fake bait, the transparent counterweight fake bait having an opening at a rear end thereof for connecting with one end of the dual-ring member, another end of the dual-ring member being pivotally connected with a front end of the colored fake bait, the colored fake bait being colored with pattern for attracting a real fish to be hooked.

2. The compact fake bait structure as claimed in claim 1, wherein the transparent counterweight fake bait is in the form of a plurality of transparent counterweight fake baits which are connected one by one.
